(19) United States
(12) Patent Application Publication
(10) Pub. No.: US 2012/0090555 A1
(43) Pub. Date: Apr. 19, 2012

(54) PET TOY

(75) Inventor: Patrick M. Bertsch, Thornton, CO (US)

(73) Assignee: DOSKOCIL MANUFACTURING COMPANY, INC., Arlington, TX (US)

(21) Appl. No.: 13/273,009

(22) Filed: Oct. 13, 2011

Related U.S. Application Data
(60) Provisional application No. 61/392,708, filed on Oct. 13, 2010.

(51) Int. Cl. A01K 29/00; B23P 11/00

(52) U.S. Cl. 119/707; 29/428

(57) ABSTRACT

A pet toy including a ball configured to roll along a surface, an axle connected to the ball, a rotating member configured to rotate around the axle, and a wire including a first end and a second end. The first end of the wire is attached to the rotating member and the second end of the wire is attached to a toy. The pet toy further includes a weight attached to the rotating member. The wire is configured to extend from the interior of the ball to the exterior of the ball.

### CROSS-REFERENCE TO RELATED APPLICATIONS

This application is related to and claims priority to U.S. Provisional patent application Ser. No. 61/392,708, entitled “Pet Toy,” filed Oct. 13, 2010, which is incorporated herein by reference in its entirety and for all purposes.

### TECHNICAL FIELD

The present disclosure generally relates to pet toys, and more particularly to pet toys that attract an animal to the toy and maintains the animal's interest in it.

### BACKGROUND

Pet owners often use pet toys to allow their pets, such as cats or dogs, to engage in natural predatory behavior. For example, many cat owners seek to engage their cats using toys that emulate prey, such as balls, fingers, stuffed animals, string, and so on. Pet toys also serve as a form of exercise and entertainment for a solitary animal, for example, when the owner is at work or otherwise not available to play with the animal. If, however, a pet toy is too easily solved or destroyed, the animal may quickly lose interest in the pet toy. Thus, it can be useful for a pet owner to have a toy that is challenging enough to maintain the animal's interest in the toy and further capable of entertaining the animal when the owner is not present.

### SUMMARY

One embodiment of the present disclosure may take the form of a pet toy including a ball configured to roll along a surface, an axle connected to the ball, a rotating member configured to rotate around the axle, and a wire including a first end and a second end. The first end of the wire is attached to the rotating member and the second end of the wire is attached to a toy. The pet toy further includes a weight attached to the rotating member. The wire is configured to extend from the interior of the ball to the exterior of the ball.

Another embodiment of the present disclosure may take the form of a pet toy including a base including a bottom surface and one or more walls extending upwardly from the bottom surface to a receiving portion defining a first opening. The one or more walls may define a second opening. The pet toy may further include a wire including a first end joined to a weight and a second end joined to a toy. The wire may extend through the first opening. A weight of the weight may counteract a weight of the toy.

### BRIEF DESCRIPTION OF THE DRAWINGS

FIG. 1 depicts a perspective view of a first embodiment of a pet toy.

FIG. 2 depicts a side view of the pet toy shown in FIG. 1 in a tilted position.

FIG. 3 depicts a rear view of the pet toy shown in FIG. 1.

FIG. 4 depicts a partial cross-section view of the pet toy shown in FIG. 1, viewed along line 4-4 in FIG. 2.

FIG. 5 depicts a perspective view of a second embodiment of a pet toy.

FIG. 6 depicts a partial cross-section view of the pet toy shown in FIG. 5, viewed along line 6-6 in FIG. 5.

FIG. 7 depicts a partial cross-section view of the pet toy shown in FIG. 5, viewed along line 7-7 in FIG. 5.

FIG. 8 depicts a detailed cross-section view of the ball receiving portion shown in FIG. 6.

FIG. 9 is a flow diagram of a method for manufacturing a pet toy.

FIG. 10 is a flow diagram of another method for manufacturing a pet toy.

### DETAILED DESCRIPTION

Described herein are pet toys for use by a pet, such as a dog, a cat, or other domesticated animal. In one embodiment, the pet toy may take the form of two hemispherical portions that are joined to form a ball. When joined, hemispherical portions may be configured to define a gap therebetween configured to receive a wire that extends through the gap from the interior of the ball to the exterior of the ball. The wire may have a first end portion that is attached to a rotating member that pivots around an axle encased in the ball and a second end portion that is attached to a toy that hangs from the wire outside the ball. The rotating member may be attached to a hanging weight so that the weight of the weight may counteract the weight of the toy, thereby maintaining the wire in a substantially upright position when the ball is stationary.

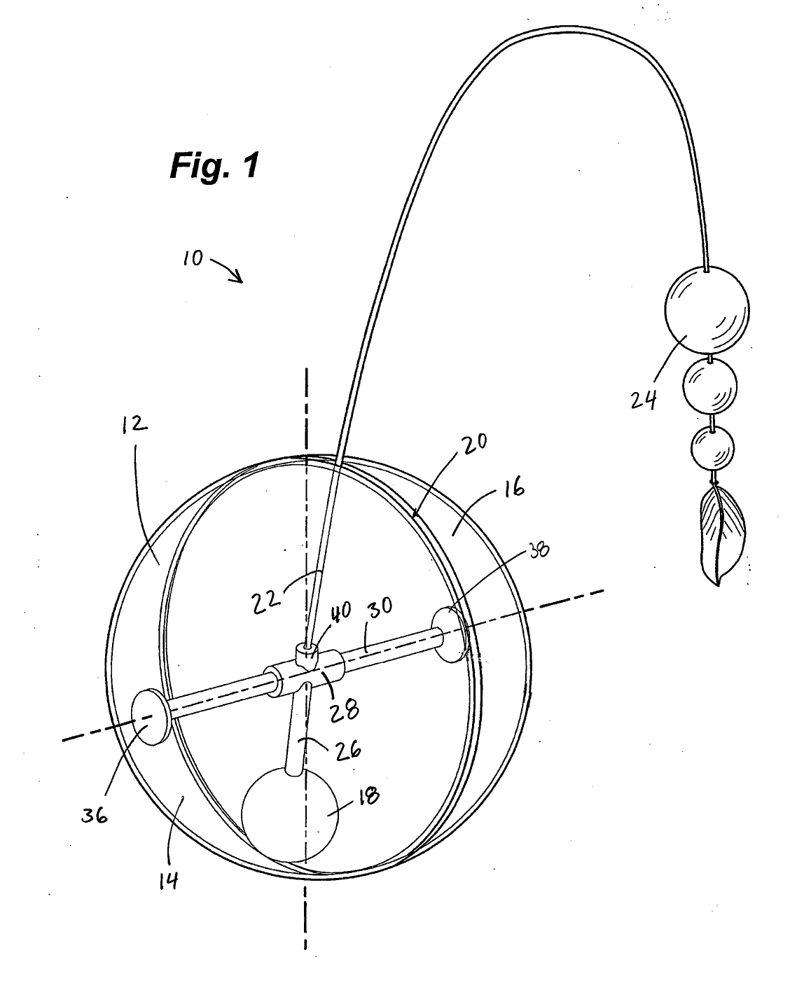

FIGS. 1-3 depict a first embodiment of a pet toy 10. With reference to FIG. 1, which shows a perspective view of the pet toy 10, the pet toy 10 may include a first hemispherical portion 14 and a second hemispherical portion 16. The first hemispherical portion 14 may be joined to the second hemispherical portion 16 so as to define a gap 20 between the first and second hemispherical portions 14, 16. When joined, the first and second hemispherical portions 14, 16 may form a substantially spherical ball 12 defining a gap 20 around its diameter. The first hemispherical portion 14 may be fixedly joined to the second hemispherical portion 16, or, in other embodiments, may be detachably joined and disconnected from the second hemispherical portion 16.

The first and second hemispherical portions 14, 16 may be made of a polymer or other suitable material. For example, the hemispherical portions 14, 16 may be formed from a styrene, a polypropylene, a polyvinyl chloride (“PVC”), or a polyethylene terephthalate (“PET”), among other materials. The material used to form the first and second hemispherical portions 14, 16 may be partially or fully transparent, so as to allow an animal to see the interior of the ball, or may be opaque. In some embodiments, the first and second hemispherical portions 14, 16 may be formed from different materials and may have different levels of transparency and/or opacity.

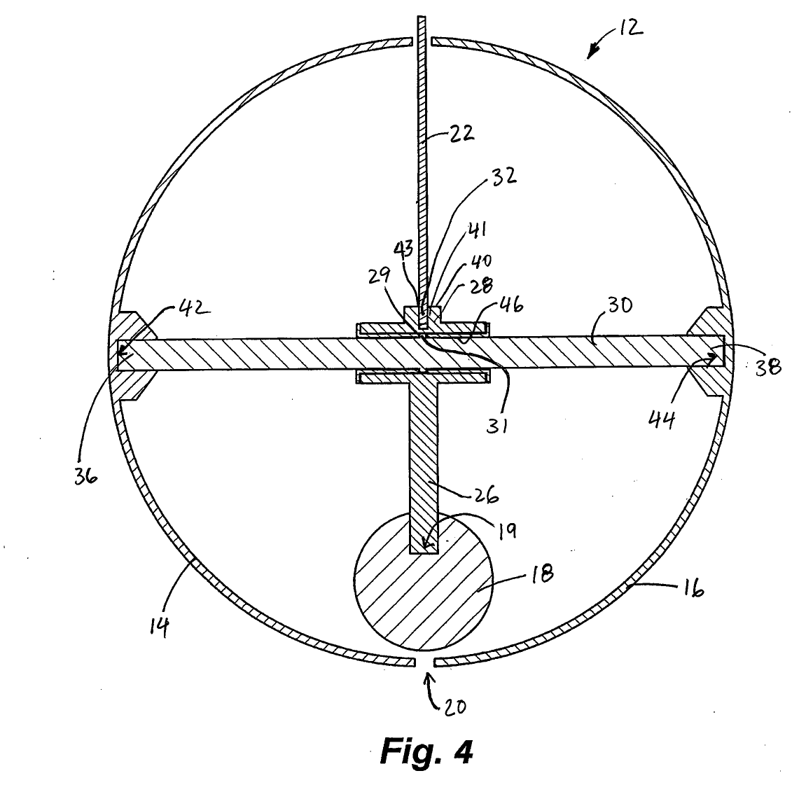

The first hemispherical portion 14 may be joined to the second hemispherical portion 16 using an axle 30 including a first end portion 36 and a second end portion 38. The axle 30 may be configured as a cylindrical rod. In one embodiment, the first end portion 36 of the axle 30 may be joined to the first hemispherical portion 14, and the second end portion 38 of the axle 30 may be joined to the second hemispherical portion 16. The first and second end portions 36, 38 of the axle 30 may be joined to the first and second hemispherical portions 14, 16 using any attachment mechanism. For example, as shown in FIG. 4, the first and second hemispherical portions 14, 16 may each define a groove 42, 44 that is configured to receive an end portion 36, 38 of the axle 30 and the first and second end portions 36, 38 of the axle 30 may be inserted into the grooves 42, 44 to join the first and second hemispherical portions 14, 16 to the axle 30. The end portions 36, 38 of the axle 30 may be friction-fitted, glued, welded, or otherwise secured to the receiving surfaces defining the grooves 42, 44.

It should be noted that other embodiments may include different mechanisms for attaching the first and second end portions 36, 38 of the axle 30 to the first and second hemispherical portions 14, 16. For example, the first and second end portions 36, 38 of the axle 30 may be secured to the first and second hemispherical portions 14, 16 by a fastener, such as a nut-and-bolt fastener, a threaded fastener, and so on and so forth. Additionally, the first and second end portions 36, 38 of the axle 30 may each be secured to a respective hemispherical portion 14, 16 using a different attachment mechanism. For example, the first end portion 36 may be glued to the first hemispherical portion 14 and the second end portion 38 may be fastened to the second hemispherical portion 16 using a nut-and-bolt fastener, and so on.

The pet toy 10 may also include a rotating member that is configured to pivot around the axle 30. For example, the rotating member 28 may include a low-friction inner surface 46 that engages the rounded outer surface 33 of the axle to 30 allow the rotating member 28 to rotate around the axle 30. In another embodiment, the rotating member 28 may include one or more rolling bearings configured to roll back and forth along the surface of the axle 30.

As shown in FIG. 4, the inner surface 46 of the rotating member 28 may define a recess 29 that is configured to receive a notch 31 defined by the outer surface 33 of the axle so that when the notch 31 is received in the recess 29, the rotating member 28 is prevented from sliding along the length of the axle 30 as the rotating member 28 rotates around the axle 30. In one embodiment, the notch 31 may be positioned at the approximate center of the axle 30 so that the notch 31 is axially aligned with the gap 20 defined between the first and second hemispherical portions 14, 16.

Referring to FIG. 4, the rotating member 28 may include a wire attachment portion 41 that is joined to a first end portion 32 of a wire 22 that extends from the wire attachment portion 41 through the gap 20. In one embodiment, the wire attachment portion 41 may define an aperture 43 that is configured to receive the first end 32 of the wire 22, and the wire 22 may be secured to the wire attachment portion 41, for example, by gluing the wire 22 to the wire attachment portion 41, tying the wire 22 to the wire attachment portion 41, and so on and so forth. Additionally, the wire attachment portion 41 may include a protruding portion 40 adjacent the aperture 43. The protruding portion 40 may be configured to surround the received wire 22 so as to help maintain the wire 22 in an upright position with respect to the rotating member 28. Still referring to FIG. 4, the rotating member 28 may also include an arm 26 that extends away from the axle 30 toward the hemispherical portions 14, 16. In one embodiment, the wire attachment portion 41 and arm 26 of the rotating member 28 may be substantially co-linear, i.e., the wire attachment portion 41 and the arm 26 may define an angle that is substantially 180 degrees with respect to one another. In other embodiments, the wire attachment portion 41 and the arm 26 may define an angle that is less than 180 degrees with respect to one another.

The end of the arm 26 may be joined to a weight 18 or mass. For example, as shown in FIG. 4, the weight 18 may be a ball including a groove 19 configured to receive the end of the arm 26, and the weight 18 may be secured to the arm 26, for example, by gluing the end of the arm 26 to the surface defining the groove 19. In other embodiments, the arm 26 and the weight 18 may be attached by a different attachment mechanism, or may be formed from a single piece of material. The weight may have any configuration, for example, the weight 18 may be a ball, as shown in FIGS. 1-4, a cube, a pyramid, and so on and so forth. The total length of the arm 26 and the attached weight 18 should be shorter than the radius R of the ball 12 so that the weight is suspended a distance above the hemispherical portions 14, 16.

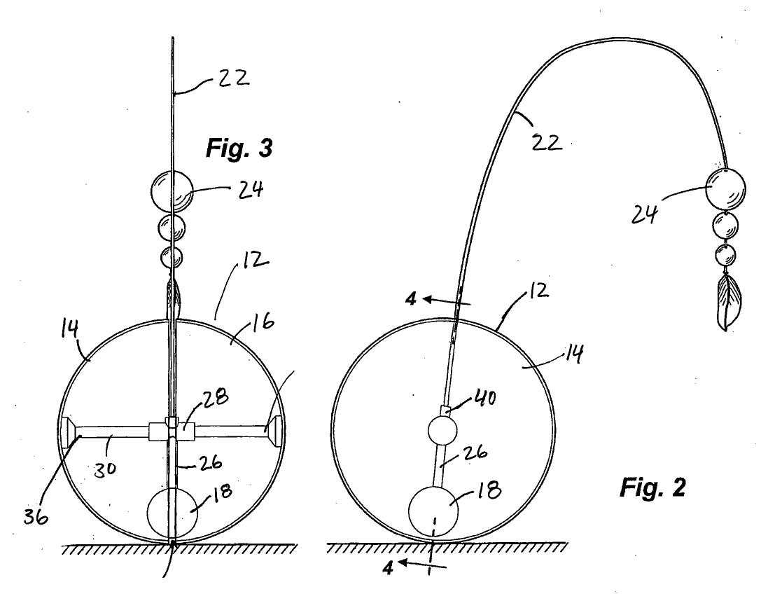

As discussed above, the wire 22 may include a first end portion 32 that is joined to the rotating member 28 and a second end portion 34 that is attached to a toy 24. More particularly, the wire 22 may extend from the rotating member 28 and through the gap 20 between the hemispherical portions 14, 16 so as to suspend the toy 24 outside the ball 12. As shown in FIG. 2, the weight of the toy 24 may cause the wire 22 to curve, however, the wire 22 should have a sufficient thickness and be formed from a sufficiently resilient material so as to maintain an upright position both when an animal is playing with the toy 24 and when the toy 24 and the ball 12 are stationary. Similarly, the wire 22 should be configured to resist folding due to the weight of the toy 24. For example, the wire 22 may be formed from metal, plastic, or any other suitable material.

The toy 24 may have any configuration so as to attract and maintain the interest of an animal. For example, the toy 24 may include a toy mouse, a toy bird, a ball (or balls), feathers, and so on and so forth. The weight of the toy 24 may be less than the weight of the weight 18 so that the weight or mass of the weight 18 may serve to counteract the weight or mass of the toy 24. Accordingly, when an animal plays with the toy 24 or when an animal pushes the ball 12, the moment arm created by the weight 18 may maintain the wire 22 in an upright position with respect to the ball 12 as the axle 30 and the ball 12 rotate relative to the rotating portion 28. Thus, to an animal playing with the toy 24, the toy 24 may appear to be traveling in an upright position along the same travel path as the ball 12.

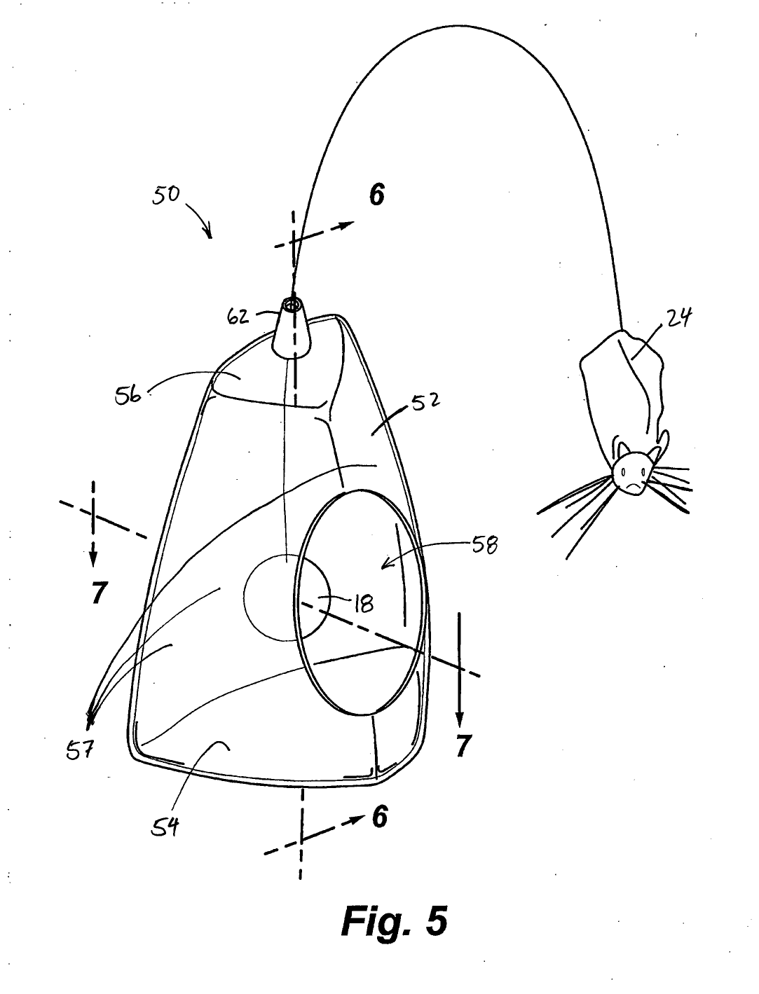

FIGS. 5-8 illustrate a second embodiment of a pet toy 50. As shown in FIG. 5, the pet toy 50 may include a base 52 including a bottom surface 54 and a plurality of walls 57 extending upwardly from the bottom surface 54 to a top surface 56. In some embodiments, the bottom surface 54 of the base 52 may include a plurality of pegs or legs, or a high-friction coating covering a portion or all of the bottom surface 54, to support and stabilize the base 52 when resting on a generally flat support surface. Some examples of frictional surfaces include rubber or roughened feet, or feet formed from another suitable material such as a soft plastic, thermoplastic or suitable resin.

The base 52 may be made of a polymer or other suitable material. For example, the base 52 may be formed of a styrene, a polypropylene, a polyvinyl chloride (“PVC”), or a polyethylene terephthalate (“PET”), among other materials.

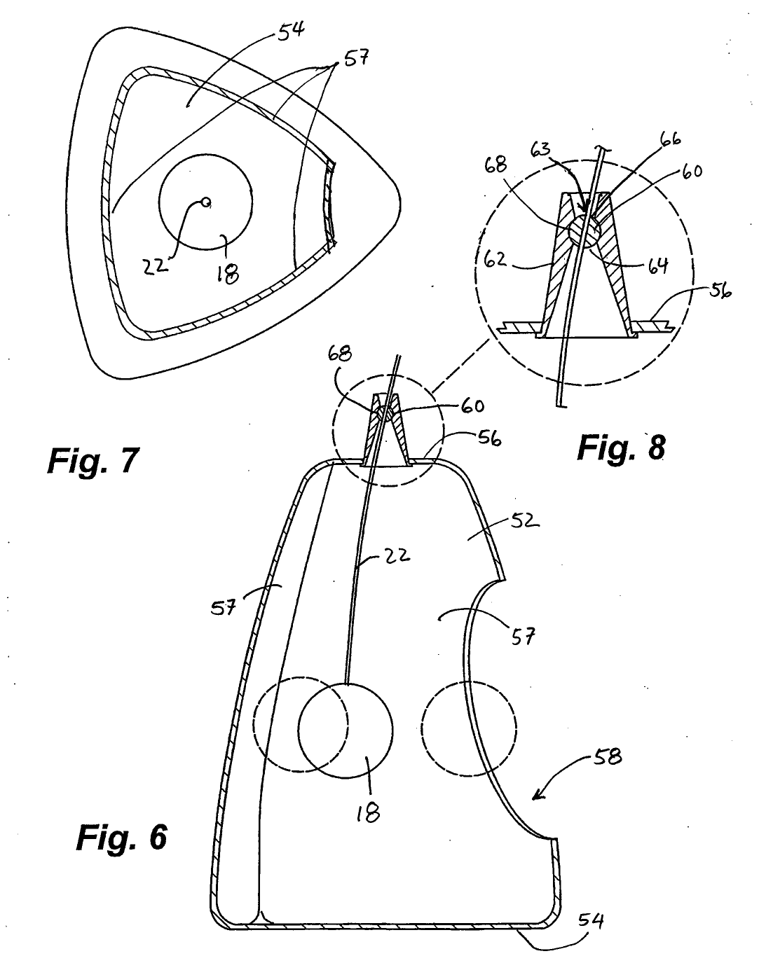

In one embodiment, the base 52 may include three sidewalls 57 that extend from a triangular-shaped bottom surface 54, as shown in FIG. 7. One or more of the sidewalls 57 may define an opening 58. For example, a portion of the opening 58 may be defined by two adjacent sidewalls 57 so that the opening 58 is positioned along an edge of the base 52. The opening 58 may have a substantially ovular configuration, as shown in FIG. 6, or, in other embodiments, may be circular, or may have a polygonal configuration. In other embodiments, the base 52 may have a different configuration. For example, the sidewalls of the base 52 may be rounded, and the bottom surface 54 may define a circle or an oval. As another example, the base 52 may have four sidewalls 57, and the bottom surface 54 may be a square or a rectangle, and so on. Further, the opening 58 may be defined in the surface of a sidewall 57.

The top surface 56 of the base 52 may define a receiving portion 62 that extends upward from the top surface 56. As best shown in FIG. 8, the receiving portion 62 may include a rounded ball receiving surface 68 that is configured to receive a ball bearing 60. The ball bearing 60 may include an aperture 63 that extends through the ball bearing 60 and is configured to receive the wire 22. To maintain the ball bearing 60 at a fixed position along the length of the wire 22, the ball bearing 60 may be joined to the wire 22, for example, by gluing the ball bearing 60 to a portion of the wire 22, or by some other attachment mechanism. For example, a stopper element that prevents the ball bearing 60 from sliding along the wire 22 may be used.

Still referring to FIG. 8, the receiving portion 62 may also define a first opening 64 below the ball receiving surface 68 that allows the wire 22 to extend from the interior of the base 52 to the outside of the base 52 through the first opening 64. The first opening 64 may be circular, polygonal, slotted, or may have any other configuration. The configuration of the first opening 64 may serve to limit the range of rotation of the ball bearing 60 relative to the ball receiving surface 68. For example, a larger first opening 64 may result in a wider pivot range, while a smaller first opening 64 may result in a more confined pivot path. Similarly, a slotted first opening 64 may only allow for a substantially linear travel path, while a circular first opening 64 may allow for a circular travel path.

The receiving portion 62 may further define a second opening 66 above the ball receiving surface 68 that prevents the ball bearing 60 from being removed from the receiving portion 62, for example, when the toy 24 is pulled in an upward direction. The second opening 66 may have any configuration. For example, the second opening 66 may be circular, and the diameter of the second opening 66 may be smaller than the diameter of the ball bearing 60. In other embodiments, the second opening 66 may have a polygonal, slotted, or other configuration so as to prevent the ball bearing 60 from being removed from the receiving portion 62.

The wire 22 may include a first end 32 and a second end 34. As shown in FIG. 5, the first end 32 of the wire 22 may be attached to a weight 18, and the second end 34 of the wire 22 may be attached to a toy 24. In one embodiment, the first end 32 of the wire 22 may be secured to the weight 18 by inserting the first end 32 of the wire 22 into an aperture 63 defined in the ball bearing 60 and gluing the first end 32 of the wire 22 to the ball bearing 60. In other embodiments, the wire 22 may be secured to the weight 18 by tying a portion of the wire 22 around the ball bearing 60, using a stopper element, and so on and so forth. The weight 22 may have any configuration, for example, the weight 18 may be a ball, as shown in FIGS. 5-8, a cube, a pyramid, and so on and so forth. As shown in FIGS. 5-7, the total length from the ball bearing 60 to the bottom of the attached weight 18 may be shorter than the distance from the ball bearing 60 to the bottom surface 54 so that the weight 18 is suspended a distance above the bottom surface 54 and allowed to swing freely without touching the bottom surface 54.

As discussed above, the second end 34 of the wire 22 may be secured to a toy 24 so that the wire 22 extends through the opening 64 defined in the receiving portion 62 so as to suspend the toy 24 outside the ball 12. The toy 24 may have any configuration so as to attract and maintain the interest of an animal. For example, the toy 24 may include a toy mouse, a toy bird, a ball (or balls), feathers, and so on and so forth. As shown in FIG. 5, the weight of the toy 24 may cause the wire 22 to curve, however, the wire 22 should have a sufficient thickness and be formed from a sufficiently resilient material so as to maintain an upright position both when an animal is playing with the toy 24 and when the toy 24 is stationary. Similarly, the wire 22 should be configured to resist folding due to the weight of the toy. For example, the wire may be formed from metal, plastic, or any other suitable material.

The weight of the toy 24 may be less than the weight of the weight 18 so that the weight of the weight 18 may serve to counteract the weight of the toy 24. Accordingly, an animal playing with the weight 18 through the opening 58 may displace the wire 22, thereby causing the ball bearing 60 to pivot relative to the ball receiving surface 68 to move the toy 24. Similarly, when an animal plays with the toy 24, the wire 22 may cause the ball bearing 60 to pivot relative to the ball receiving surface 68 to move the weight 18. However, the moment arm created by the weight 18 may maintain the wire 22 in an upright position with respect to the base 52.

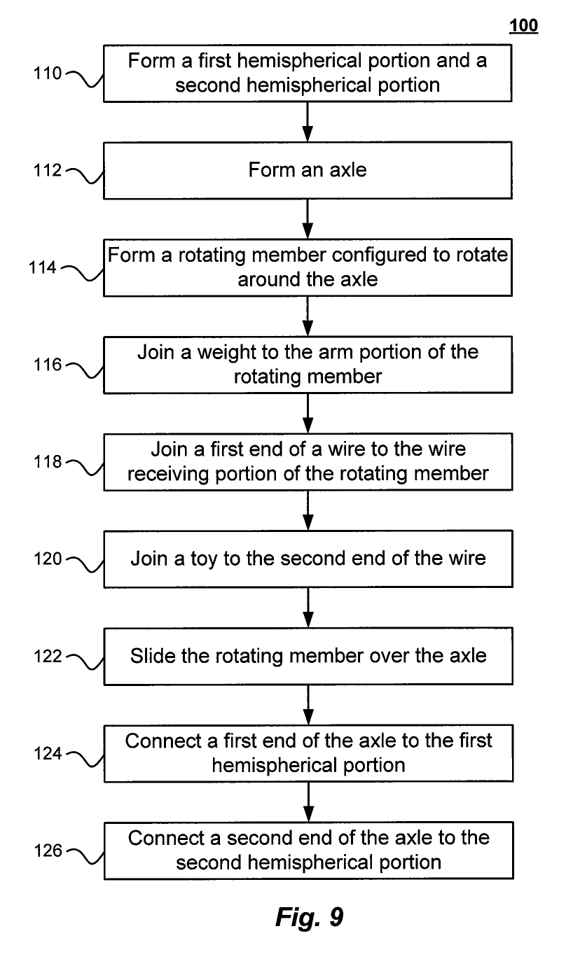

As shown in FIG. 9, another embodiment may take the form of a method 100 of manufacturing a pet toy. The method includes forming a first hemispherical portion and a second hemispherical portion at operation 110. The first and second hemispherical portions may define a gap therebetween. Operation 112 includes forming an axle. Operation 114 includes forming a rotating member that is configured to rotate around the axle. The rotating member may include an arm portion that extends away from the axle, and a wire receiving portion that is configured to receive a wire. Operation 116 includes joining a weight to the arm portion of the rotating member. Operation 118 includes joining a first end of a wire to the wire receiving portion of the rotating member. Operation 120 includes joining a toy to a second end of the wire. The weight of the toy may be less than the weight of the weight attached to the arm portion. Operation 122 includes sliding the rotating member over the axle. Operation 124 includes connecting a first end of the axle to the first hemispherical portion. Operation 126 includes connecting a second end of the axle to the second hemispherical portion.

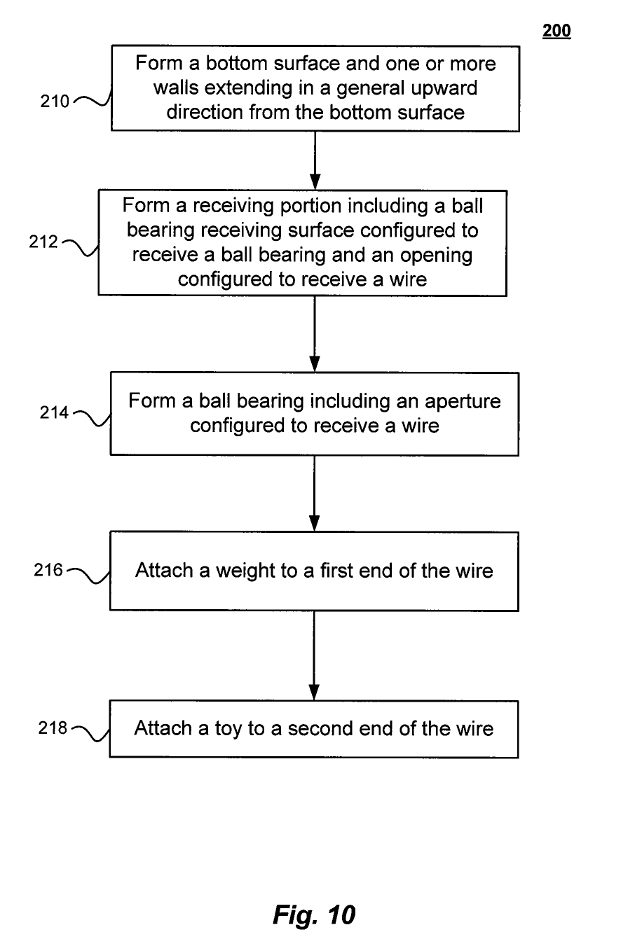

As shown in FIG. 10, another embodiment may take the form of a method 200 of manufacturing a pet toy. The method may include forming a bottom surface and one or more walls that extend in a generally upward direction from the bottom surface at operation 210. One or more of the one or more walls may define an opening. Operation 212 includes forming a receiving portion that includes a ball bearing receiving surface configured to receive a ball bearing and an opening configured to receive a wire. In one embodiment, the receiving portion may protrude from a top surface of the base. Operation 214 includes forming a ball bearing including an aperture configured to receive a wire. Operation 216 includes attaching a weight to a first end of the wire. Operation 218 includes attaching a toy to a second end of the wire.

It should be noted that all directional references set forth herein (e.g., upper, lower, upward, downward, left, right, leftward, rightward, top, bottom, above, below, vertical, horizontal, clockwise, and counterclockwise) are relative and only used for identification purposes to aid the reader's understanding of the embodiments of the present disclosure, and are not limitations, particularly as to the position, orientation, or use of the invention unless specifically set forth in the claims. References to any joinder of elements (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

What is claimed is:

1. A pet toy comprising:
a ball configured to roll along a surface;
an axle connected to the ball;
a rotating member configured to rotate around the axle;
a wire including a first end and a second end, the first end of the wire attached to the rotating member and the second end of the wire attached to a toy; and
a weight attached to the rotating member;
wherein the wire is configured to extend from the interior of the ball to the exterior of the ball.

2. The pet toy of claim 1, wherein the ball comprises a first hemispherical portion and a second hemispherical portion defining a gap therebetween and the wire extends through the gap.

3. The pet toy of claim 1, wherein a mass of the weight counteracts a mass of the toy.

4. The pet toy of claim 2, wherein the gap extends around the diameter of the ball.

5. The pet toy of claim 1, wherein the pet toy further comprises an arm including a first end and second end, the first end of the arm attached to the rotating member and the second end of the arm attached to a weight.

6. The pet toy of claim 2, wherein the first hemispherical portion is connected to the second hemispherical portion by the axle.

7. The pet toy of claim 2, wherein the weight is suspended above the first and second hemispherical portions.

8. A method for manufacturing a pet toy comprising:
forming a ball comprising a first hemispherical portion and a second hemispherical portion;
forming an axle;
forming a rotating member that is configured to rotate around the axle;
connecting a weight to the rotating member;
joining a first end of a wire to the rotating member;
joining a second end of the wire to a toy;
sliding the rotating member over the axle;
joining a first end of the axle to the first hemispherical portion; and
joining a second end of the axle to the second hemispherical portion.

9. The method of claim 8, wherein the weight is connected to the rotating member by joining a first end of an arm to the weight and joining a second end of an arm to the rotating member.

10. The method of claim 8, wherein the first hemispherical portion and a second hemispherical portion define a gap therebetween.

11. The method of claim 8, wherein the wire extends through the gap defined by the first and second hemispherical portions.

12. A pet toy comprising:
a base including a bottom surface configured to engage a surface and one or more walls extending upwardly from the bottom surface to a receiving portion defining a first opening, the one or more walls defining a second opening;
a wire including a first end joined to a weight and a second end joined to a toy, the wire extending through the first opening;
wherein a weight of the weight counteracts a weight of the toy.

13. The pet toy of claim 12, wherein the wire is attached to a ball bearing and the receiving portion includes a ball receiving surface configured to allow the ball bearing to pivot relative to the receiving portion.

14. The pet toy of claim 12, wherein the second opening is sized so as to allow an animal to access the weight through the second opening.
